(19) United States
(12) Patent Application Publication
(10) Pub. No.: US 2005/0108417 A1
(43) Pub. Date: May 19, 2005

(54) System and method for reducing subscriber database loads

(76) Inventor: Serge Haumont, Helsinki (FI)

Correspondence Address: CRAWFORD MAUNU PLLC, 1270 NORTHLAND DRIVE, SUITE 390, ST. PAUL, MN, 55120, US

(21) Appl. No.: 10/717,427

(22) Filed: Nov. 19, 2003

(51) Int. Cl. G06F 15/16; G06F 15/173

(52) U.S. Cl. 709/232; 709/238

(57) ABSTRACT

A system, apparatus and method for mitigating subscriber database loads. Messaging routing information obtained from a subscriber database at the sending side of a message transaction is sent along with the message to the receiving side of the message transaction, thereby obviating the need for the receiving side to obtain the same information from the subscriber database. Caching may be used at the sending and/or receiving side of the message transaction to further reduce the need for queries to the subscriber database. In more involved embodiments such as MMS transfers, the message routing information can include subscriber identities to subscriber notification network elements to further reduce queries to the subscriber database.

### FIELD OF THE INVENTION

This invention relates in general to communication of messages, and more particularly to a system, method and apparatus for mitigating subscriber database loads.

### BACKGROUND OF THE INVENTION

Advances in networking infrastructures, protocols, and user devices have significantly enhanced communications. Wireless technologies have allowed society to retain the ability to communicate while on the go, and an ever-increasing segment of society carries at least one mobile communicator wherever they go. These mobile devices include, for example, mobile phones, Personal Digital Assistants (PDAs), laptop/notebook computers, and the like. The popularity of these devices and the ability to communicate wirelessly has spawned a multitude of new wireless systems, devices and protocols. Consumer demand for advanced wireless functions and capabilities has also fueled a wide range of technological advances in the utility and capabilities of wireless devices. Wireless/mobile devices not only allow voice communication, but also facilitate messaging, multimedia communications, e-mail, Internet browsing, and access to a wide range of wireless applications and services.

Messaging services have become particularly popular. Messaging generally refers to non-real-time, client-server based communication where an intermediary server(s) is typically involved in the communication sequence. The intermediary server stores and/or processes messages before they are delivered to the destination. Through messaging services, wireless and landline communication devices can communicate quickly and conveniently. The launching of the Short Message Service (SMS) evolved into an extremely successful data service, and the Multimedia Messaging Service (MMS) is an evolutionary step from SMS that is poised to enjoy even greater success. SMS messaging involves the convenient communication of short text messages. Enhanced Messaging Service (EMS) allows for messages that include text, but also may include limited content such as ring tones and monochrome bitmap pictures. MMS provides a significant step forward in the transmission of content, as it offers a wide variety of rich content types such as color pictures, audio, music, video clips, Java games, and the like.

Messaging such as SMS and MMS can be implemented with existing networks such as the Global System for Mobile Communications (GSM) which may further involve a General Packet Radio System (GPRS). An important addition to the network architecture where such messaging is supported is a messaging service center. For SMS communications, a Short Message Service Center (SMSC) is used, and a Multimedia Messaging Service Center (MMSC) is used for MMS communications. These messaging centers operate as store-and-forward units that are responsible for delivering the messages to the destination devices, yet they operate in connection with the underlying network infrastructure. For example, these messaging centers work in concert with network elements/nodes such as the Mobile Switching Center (MSC), Home Location Register (HLR), and other switching system elements.

However, services such as SMS and MMS can significantly increase the load placed on subscriber databases such as the HLR. This load increase is due to the increase in queries to such subscriber databases resulting from the SMS/MMS operations. Today's HLR technologies may currently be able to handle the load, but network traffic levels are currently manageable. As network traffic continues to increase, these subscriber database loads will also increase. In addition, the users only connect to the network when the message transaction occurs, which requires further queries of the subscriber database. Each time an attach or detach procedure is performed, the HLR is queried. For example, HLR queries could be reduced by having the mobile stations continually GPRS connected, but this would thwart the benefits of non-circuit-switched message transfers. Further, such a solution is not controlled by the operator, but rather is based on user settings.

Therefore, functions such as location of network entities and/or communication endpoints may require a significant amount of overhead, and burden the HLRs or other subscriber databases. With traffic growing and limited HLR capacity, operators will need a more optimized solution. Accordingly, there is a need in the communications industry for a manner of optimizing the network by reducing the load on such network components. The present invention fulfills these and other needs, and offers other advantages over the prior art.

### SUMMARY OF THE INVENTION

To overcome limitations in the prior art described above, and to overcome other limitations that will become apparent upon reading and understanding the present specification, the present invention discloses a system, apparatus and method for reducing the number of subscriber database queries required in connection with the communication of messages.

In accordance with one embodiment of the invention, a system is provided for reducing database queries in connection with message transmissions. The system includes a subscriber database for storing message routing information for a plurality of mobile device subscribers, and the message routing information includes subscriber information and addresses of network nodes to which the subscribers are currently registered. A sending network element is provided, and is configured to retrieve the message routing information from the subscriber database for a destination subscriber among the plurality of mobile device subscribers. The sending network element is configured to transmit at least one message and the message routing information towards the destination subscriber. A messaging center is provided which is coupled to receive the message and the message routing information from the sending network element via a data network. The messaging center facilitates transmission of the message to a mobile device of the destination subscriber using to the message routing information received from the sending network element.

According to more particular embodiments of such a system, a cache is provided to store the message routing information for use with transmission of at least one subsequent message towards the destination subscriber. In another embodiment, the sending network element is coupled to the cache and configured to query the cache to obtain the stored message routing information. In such a case, the network element may further be configured to transmit the message and the stored message routing information from the cache, if the cache contains the message routing information. The cache may be configured to retrieve the message routing information from the subscriber database if the cache does not contain the message routing information. In an alternative embodiment, the messaging center is configured to query the cache to request that the cache obtain the stored message routing information if the message routing information is not received by the messaging center, or if the subscriber information is unknown to the network node identified by the address provided via the message routing information. In yet another embodiment, the messaging center is configured to query the subscriber database to obtain the message routing information if the message routing information is not received by the messaging center or if the subscriber information is unknown to the network node identified by the address provided via the message routing information.

According to another embodiment of such a system, the sending network element represents a sending Multimedia Messaging Service Center (MMSC), the messaging center represents a receiving MMSC, and the message is a Multimedia Messaging Service (MMS) message. In a more particular embodiment, the system further includes a push proxy gateway coupled to the receiving MMSC to receive the subscriber information and the network node address provided by the sending MMSC. A notification node is provided to notify a mobile station associated with the destination subscriber that the MMS message is available, where the notification node is coupled to receive the subscriber information and the network node address for use in identifying the destination subscriber. In one embodiment, the receiving MMSC is configured to provide the subscriber information and the network node address to the push proxy gateway via a field of a Push Access Protocol (PAP), and in another embodiment, the push proxy gateway is configured to provide the subscriber information and the network node address to the notification node via a Short Message Service (SMS) message. In yet another embodiment, the sending MMSC is configured to transmit the at least one message and the message routing information to the receiving MMSC via an MM4 interface.

In accordance with another embodiment of the invention, a method is provided for reducing queries associated with the transmission of messages over a network. The method includes initiating a query from at least one network element involved in the transmission of messages to a subscriber database associated with a destination subscriber. In response to the query, message routing information is received for transmitting at least one message from the network element towards the destination subscriber. The message and the message routing information is transmitted from the network element to a messaging center associated with the destination subscriber. The message is transmitted from the messaging center to a delivery node for ultimate delivery to the destination subscriber, where the message is transmitted from the messaging center to the delivery node identified by the message routing information received from the network element.

In accordance with another embodiment of the invention, a network element is provided for facilitating the transmission of messages over a network. The network element includes a query module configured to formulate a query to a subscriber database associated with a destination subscriber. A network interface transmits the query and receives message routing information in response. A message transmission module associates the message with the message routing information. The network interface transmits the message and associated message routing information to a messaging center serving the destination subscriber, where the message routing information includes a subscriber identity of the destination subscriber and an address of a delivery node for use by the messaging center in delivering the message to the destination subscriber.

In accordance with another embodiment of the invention, a computer-readable medium is provided having instructions stored thereon that are executable by a computer system for reducing queries associated with the transmission of messages over a network. The computer-executable instructions perform steps including initiating a query to a subscriber database associated with a destination subscriber, and receiving message routing information for transmitting a message towards the destination device. The computer-executable instructions further perform the step of transmitting the message and the message routing information to a messaging center associated with the destination subscriber to facilitate transmission of the message from the messaging center to the destination subscriber using the message routing information.

These and various other advantages and features of novelty which characterize the invention are pointed out with particularity in the claims annexed hereto and form a part hereof. However, for a better understanding of the invention, its advantages, and the objects obtained by its use, reference should be made to the drawings which form a further part hereof, and to accompanying descriptive matter, in which there are illustrated and described particular examples of a system, apparatus, and method in accordance with the invention.

### BRIEF DESCRIPTION OF THE DRAWINGS

The invention is described in connection with the embodiments illustrated in the following diagrams.

FIG. 1 illustrates some general aspects of a GSM/GPRS network environment in which the principles of the present invention may be employed;

FIG. 2 is a block diagram illustrating one embodiment of the invention where the subscriber database load is reduced in connection with messaging communication;

FIG. 3 is a block diagram illustrating an embodiment of the invention where the subscriber database load is reduced in connection with Short Message Service messaging;

FIG. 4 is a flow diagram illustrating one embodiment of a method for reducing queries associated with the transmission of messages over a network;

FIGS. 5A and 5B illustrate representative embodiment of the invention utilizing caching to further reduce query volume;

FIG. 6 is a flow diagram illustrating one embodiment of a method implementing a cache for reducing queries associated with the transmission of messages over a network;

FIG. 7 is a block diagram illustrating one embodiment of the invention where subscriber database queries are reduced in connection with the transfer of MMS messages; and

FIG. 8 is a block diagram illustrating a representative implementation of a network element capable of carrying out operations in accordance with the invention.

### DETAILED DESCRIPTION OF THE INVENTION

In the following description of the exemplary embodiment, reference is made to the accompanying drawings which form a part hereof, and in which is shown by way of illustration various embodiments in which the invention may be practiced. It is to be understood that other embodiments may be utilized, as structural and operational changes may be made without departing from the scope of the present invention.

Generally, the present invention provides a manner of reducing the number of queries implicating subscriber databases. Messaging routing information obtained from a subscriber database at the sending side of a message transaction is sent along with the message to the receiving side of the message transaction, thereby obviating the need for the receiving side to obtain the same information from the subscriber database. In one embodiment, the message routing information includes the address of a network entity such as an MSC/VLR to which the targeted recipient is registered, and therefore such a network entity can be identified on the recipient side without further queries to the subscriber database. In some embodiments, caching is used at the sending and/or receiving side of the message transaction to further reduce the need for queries to the subscriber database. In one embodiment, the message routing information includes a subscriber identity such as an IMSI, which can be used to identify the recipient subscriber which further reduces the need for subscriber database queries. With new technologies increasingly causing the loads on subscriber database to escalate, the present invention provides an elegant solution for mitigating such loads on the subscriber databases.

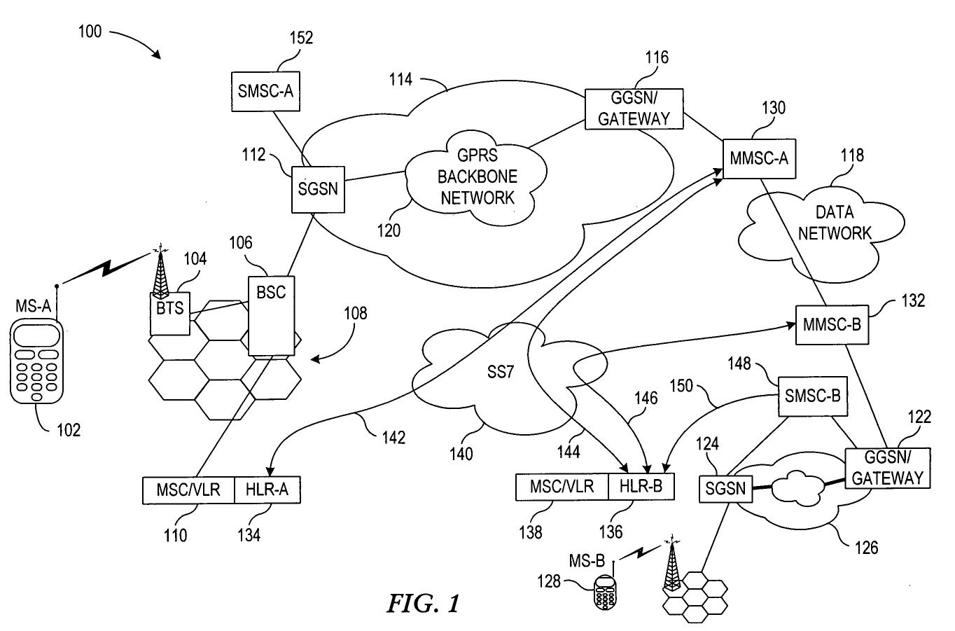

The present invention is applicable in any type of mobile communication systems/networks where messaging is employed. In order to facilitate an understanding of the invention, the present invention is described in terms of a GSM/GPRS network. FIG. 1 illustrates some general aspects of a GSM/GPRS network environment 100 in which the principles of the present invention may be utilized.

Global System for Mobile communications (GSM) is a digital cellular communications system serving as a Public Land Mobile Network (PLMN), where multiple providers may set up mobile networks following the GSM standard. GSM is capable of providing both voice and data services. A GSM (or analogous) network 100 typically includes components such as Mobile Stations (MS), Base Transceiver Stations (BTS), Mobile Switching Center (MSC)/Visiting Location Register (VLR), etc. A GSM network may be viewed as a collection of various subsystems, including the Radio Subsystem (RSS) which covers radio aspects, Network and Switching Subsystem (NSS) which manages functions such as call forwarding, handover and switching, and the Operation Subsystem (OSS) that manages the network. Various aspects of the RSS are described in greater detail below.

For purposes of illustration and not of limitation, FIG. 1 is described in the context of a General Packet Radio System (GPRS) mobile communications network. GPRS is a packet-switched service for GSM that mirrors the Internet model and enables seamless transition towards 3G (third generation) networks. GPRS thus provides actual packet radio access for mobile GSM and time-division multiple access (TDMA) users, and is ideal for Wireless Application Protocol (WAP) services. While the exemplary embodiments of FIG. 1 and other illustrated embodiments are generally described in connection with GPRS, and GSM which is the underlying digital technology of GPRS, it should be recognized that the specific references to GSM and GPRS are provided to facilitate an understanding of the invention. As will be readily apparent to those skilled in the art from the description provided herein, the invention is equally applicable to other current and future network technologies.

One or more MSs 102 communicate with the BTS 104 via an air interface. The BTS 104 is a component of a wireless network access infrastructure that terminates the air interface over which subscriber traffic is communicated to and from the MS 102. The Base Station Controller (BSC) 106 is a switching module that provides, among other things, handoff functions, and controls power levels in each BTS 104 of the Base Station System (BSS) 108. The BSC 106 controls the interface between a Mobile Switching Center (MSC) 110 and BTS 104 in a GSM mobile wireless network, and thus controls one or more BTSs in the call set-up functions, signaling, and in the use of radio channels. The BSC 106 also controls the interface between the Serving GPRS Support Node (SGSN) 112 and the BTS 104 in the GPRS network 114, as described more fully below. Other BTS, BSC, and related mobile network components may also be associated with the network system.

GPRS Support Nodes (GSNs) are introduced into a GSM network in order to integrate GPRS into the existing GSM network. GSNs are responsible for the delivery and routing of data packets between MSs and external packet data networks (PDNs). The Serving GPRS Support Nodes (SGSN) 112 serves GPRS mobile by sending or receiving packets via the BSS 108, and more particularly via the BSC 106 in the context of GSM systems. The SGSN 112 is responsible for the delivery of data packets to and from the mobile stations within its service area, and performs packet routing and transfer, mobility management, logical link management, authentication, charging functions, etc. In the exemplary GPRS embodiment shown in FIG. 1, a location register of the SGSN 112 stores location information such as the current cell and Visiting Location Register (VLR) associated with the MS 102, as well as user profiles such as the International Mobile Subscriber Identity number (IMSI) of all GPRS users registered with this SGSN 112.

Another network element/node introduced in the GPRS context is the Gateway GPRS Support Node (GGSN) 116 or other gateway, which serves as a gateway between the GPRS network 114 and a packet-switched data network, such as data network 118. This gateway 116 allows mobile subscribers to access the data network 118 such as the Internet or specified private IP networks. The connection between the GGSN 116 and the data network 118 is generally enabled through a standard protocol, such as the Internet Protocol (IP). GSNs such as the SGSN 112 and GGSN 116 are connected via a GPRS backbone network 120. Within this backbone, packets are encapsulated and transmitted or “tunneled,” such as via the GPRS Tunneling Protocol (GTP). Similar GSNs 122, 124 are associated with other operator networks 126.

Messaging services, such as Short Message Service (SMS) and Multimedia Messaging Service (MMS), may be provided over such networks. These messaging technologies are “store-and-forward” message services that allow mobile subscribers to exchange messages with other mobile subscribers. SMS allows for communication of text messages between device users. Messages sent by a source device are received by an SMS Center (SMSC) that provides the store-and-forward functionality, and is responsible for delivering the message(s) to the destination device. The SMSC stores the message until the destination device is available, at which time it forwards the message to the destination, removes it from the SMSC, and notifies the sender that the message has been forwarded.

MMS, also based on the store-and-forward service model, is similar to SMS in the manner that messages are communicated. However, unlike SMS, MMS is not limited to text messages, and can include images, video, audio, or other rich content instead or in addition to text. In sending multimedia messages, the destination address used may be the recipient's public number such as the Mobile Station Integrated Services Digital Network Number (MSISDN), or may be an e-mail address. Depending on the addressing scheme employed, the messages will be routed differently; e.g., a message sent to an MSISDN will be routed to the recipient, while a message routed to an e-mail address will be routed directly to the e-mail server (e.g., SMTP) that in turn handles the delivery.

MMS messages are routed by way of MMS Centers (MMSC). For example, where Mobile Station-A (MS-A) 102 sends an MMS message targeted for MS-B 128 associated with another operator network 126, MMSC 130 and MMSC 132 will be involved. The MMSC 130 associated with the sender's operator network makes certain queries to the Home Location Registers (HLRs) 134, 136 of the sender and recipient respectively, and then sends the message over the data network 118 to the MMSC 132. Such queries are described more fully below.

The HLRs 134, 136 represent databases that store and manage subscriptions, including a subscriber's service profile, location information, activity status, etc., and are maintained by one or more service providers for their respective subscribers. The MSC/VLR 110, 138 represent the Mobile Services Switching Center (MSC) functionality and the Visitor Location Register (VLR) functionality. The MSC functionality includes providing switching services and controlling calls between telephone and data systems, switching voice traffic from the wireless network to the landline network if the call is a mobile-to-landline call, or alternatively switching to another MSC if the call is a mobile-to-mobile call. The MSC also provides the mobility functions for the network, and serves as the hub for multiple BTSs. Generally, it is the MSC that provides mobility management for subscribers, in order to register subscribers, and authenticate and authorize services and access for subscribers. The MSC uses the information stored in its respective HLR to authenticate and register the subscriber by storing permanent subscriber information including the service profile, the current location of mobile stations, and activity status of the mobile user. The VLR is a database that may be maintained by the MSC to keep track of all the visiting mobile stations within a mobile telephony system.

When SMS, EMS, and other message communications are performed, the HLR or analogous database is queried to obtain certain information. As an example, when an MMS transfer occurs, the HLRs 134, 136 are heavily accessed. For example, in a GPRS environment, MS-A 102 performs a GPRS attach procedure that involves a location update and insertion of subscriber data to the HLR-A 134. Further, the MMSC-A 130 queries HLR-A 134 via the Signaling System 7 (SS7) network 140 using MS-A's 102 MSISDN to determine whether MS-A 102 is roaming from the MSC 110 address. This query is illustrated via path 142 through the SS7 network 140. As is known in the art, an SS7 network is a system on the Public Switched Telephone Network (PSTN) that performs out-of-band signaling in support of the call establishment, billing, routing, and information exchange functions of the PSTN. Other HLR procedures involve the MMSC-A 130 checking MS-B's 128 operator identity to find MMSC-B 132. More particularly, MMSC-A 130 can query the HLR-B 136 using MS-B's 128 MSISDN to find MS-B's IMSI that is used to obtain the MMSC-B 132 address, as shown by path 144. MMSC-B 132 then determines if MS-B 128 is roaming by contacting HLR-B 136 as shown by path 146, and sends an incoming message notification to MS-B 128 by way of SMSC-B 148 which also contacts HLR-B 136 as shown by path 150. MS-B 128 then performs a GPRS attach involving HLR-B 136, and a delivery notification is sent to MS-A 102 via SMS, thus requiring SMSC-A 152 to contact HLR-A 134. After the transfer, GPRS detach procedures are performed, and a mobile station purge procedure is performed to both HLR-A 134 and HLR-B 136.

As can be seen by this representative example, a large number of procedures towards the HLRs are performed. With network traffic continuing to grow, and with limited HLR capacities, a more optimized solution for the operator is needed. New services such as MMS tend to increase the number of HLR queries, and continual expansion of wireless service use will further test existing infrastructures. The present invention provides a manner of reducing the transactions that are required in MMS, SMS, and other messaging environments by reducing queries to the HLR (or analogous) databases. The present invention also provides additional manners for improving messaging efficiency and optimizing the network.

For purposes of facilitating an understanding of the invention, various embodiments of the invention are described in terms of HLRs. It is noted, however, that the present invention is applicable regardless of the particular database(s) used by the networking system to store information analogous to that stored by HLRs. Therefore, the present invention is equally applicable to reducing the load on databases other than HLRs that store similar information. For example, third generation (3G) and subsequent generation networks may not refer to such databases as HLRs, but the invention is equally applicable to such substitute or forthcoming network elements/databases that store all or a relevant subset of the information referred to as being stored in HLRs. For example, in one embodiment the relevant information currently stored in HLRs includes MSISDNs (or other user addresses) used to determine if a user is roaming; home network switching element addresses (e.g., MSC address); user IMSIs, and the like. The present invention is applicable where databases other than HLRs store similar information.

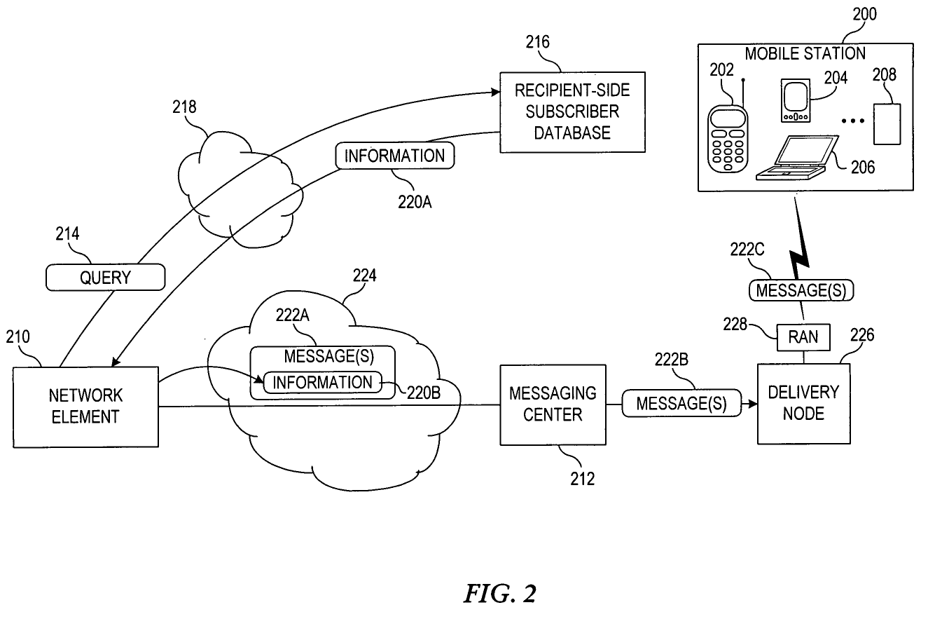

FIG. 2 is a block diagram illustrating one embodiment of the invention, where the HLR (or analogous database) load is reduced in connection with messaging communication. In the illustrated embodiment, it is assumed that a message such as an SMS message is targeted for the mobile station (MS) 200. The MS 200 represents any mobile device capable of receiving such messages, including but not limited to a mobile phone 202, personal digital assistant (PDA) 204, laptop or other portable computing device 206, or other mobile device 208. The message(s) targeted for the MS 200 is being sent by a product or network element 210, although the message may have originated elsewhere such as from another MS. The network element 210 represents any intermediary network element from which such a message may be forwarded to a messaging center 212. For example, the network element 210 may be a Wireless Access Protocol (WAP) gateway, presence server, terminal management server, messaging gateway, payment server, other messaging center such as an MMSC, or the like. The messaging center 212 represents a messaging center appropriate for the type of message(s) being transmitted, such as an SMSC, MMSC, etc.

In accordance with the invention, information that would otherwise need to be retrieved at the recipient side is obtained by the sending network element 210 and provided to the recipient side. In this manner, the messaging center 212 can forward the message to the MS 200 without having to perform additional queries to obtain that information. In one embodiment, the network element performs a query 214 to the recipient-side subscriber database 216, such as an HLR. Such a query 214 may occur over a network such as an SS7 network 218 or other network by which the subscriber database 216 can be accessed. Current messaging technologies provide for such a query 214, using the MSISDN of the recipient MS 200 to obtain the IMSI and MSC address associated with the recipient MS 200. For example, the SS7 signaling protocol includes an ISDN User Part (ISUP) used to establish and release calls, as well as a Mobile Application Part (MAP) used for signaling that is not call-related, such as signaling for different services such as GPRS services, SMS services, etc. The MAP primitives for SMS include those between the messaging gateway and the HLR. For example, the SMS management services include the “MAP-SEND-ROUTING-INFO-FOR-SM” service which may be used to retrieve routing information to route an SMS message to the servicing MSC. This activity retrieves the IMSI and MSC data using an MSISDN by querying the HLR. In this manner or analogous manner, the query 214 to the subscriber database 216 may retrieve information 220A from the subscriber database 216 which is therefore obtained at the network element 210.

In accordance with the invention, the address of a node, to which the MS 200 is registered and which is used to deliver a message to the MS 200, is provided to the messaging center 212. Such a node may be, for example, an MSC/VLR or SGSN where the MS 200 is registered. Because the address of such a node can be included in the information 220A and obtained by the network element 210, the network element 210 can in turn provide at least some of that information 220B to the messaging center 212 in connection with sending the message 222A to the messaging center 212 over the network 224. Using the information 220B, the messaging center 212 will know where the MS 200 is registered and can send the message 222B to the appropriate delivery node 226. The messaging center 212 can forward this message 222B without having to itself query the subscriber database 216, which it would otherwise have to do. The delivery node 226 then delivers the message 222C to the recipient MS 200 via the appropriate network connections and Radio Access Network (RAN) 228.

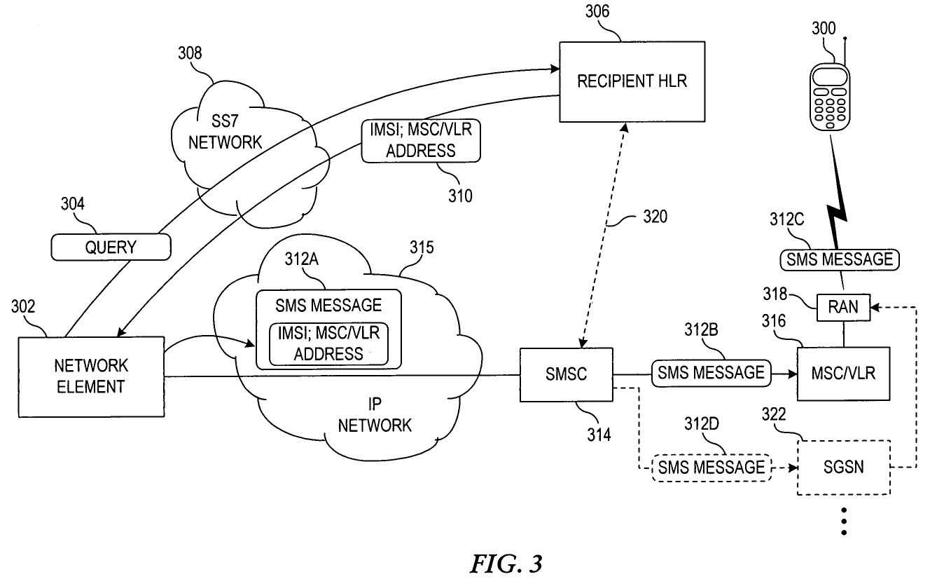

As a more particular example, assume the message represents an SMS message, the messaging center represents an SMSC, the recipient-side subscriber database represents an HLR, and the delivery node represents an MSC/VLR. Such an example is illustrated in FIG. 3. An SMS message is targeted for the MS 300, and is being sent by the network element 302, although the SMS message may have originated elsewhere. The network element 302 initiates a query 304, using the MSISDN of the MS 300, to the recipient-side HLR 306 by way of the SS7 network 308. In the illustrated embodiment the MS 300 is registered at an MSC/VLR. The HLR 306 responds to the query 304 with information 310 that includes an address of the MSC/VLR to which MS 300 is registered, and the IMSI of MS 300. The network element 302 provides the MSC/VLR address, and in one embodiment also provides the INISI, along with the SMS message 312A to the SMSC 314 over the IP network 315. The SMSC 314 then forwards the SMS message 312B to the MSC/VLR 316 to which the SMSC 314 now has the address. The SMSC 314 can forward the message 3122B without having to query the HLR 306, since it will already have the MSC/VLR address that was provided by the network element 302. The MSC/VLR 316 then delivers the message 312C to the MS 300 via the appropriate RAN 318.

In one embodiment of the invention, the SMSC 314 (or other messaging center) is configured to query the HLR 306 as a contingency procedure if the SMS 312B transfer using the MSC/VLR address received from the network element 302 fails. This may occur, for example, where the IMSI provided via the SMS message 312A is unknown to the MSC/VLR 316. In such case the MSC/VLR 316 will notify the SMSC 314 of such a failure, and the SMSC can then query the HLR 306 as shown by dashed query path 320. It should be noted that the MS 300 may be registered somewhere other than at the MSC address that is returned to the network element 302. If a different MSC address, or an address of another entity to which the MS 300 is registered (e.g., SGSN) is received from the HLR 306, the SMSC 314 will transfer the SMS to this new MSC and/or SGSN. This is illustrated by the SMS message 312D which is transferred to the SGSN 322, assuming the HLR 306 responded to the SMSC 314 query with an SGSN address.

According to one embodiment, if the MSC address (and no SGSN address) received by the SMSC 314 in response to the query 320 is the same as the MSC address received with the SMS message 312A, the SMSC will not attempt another transmission of the SMS message to that same MSC/VLR 316. Rather, the SMSC 314 may directly provide the status that another entity such as a gateway MSC would ordinarily provide. For example, the SMSC 314 may directly send a “MAP-REPORT-SM-DELIVER-STATUS” to the HLR 306. This service is used to set the Message Waiting Data into the HLR 306 so that the HLR 306 will set the appropriate alert flag.

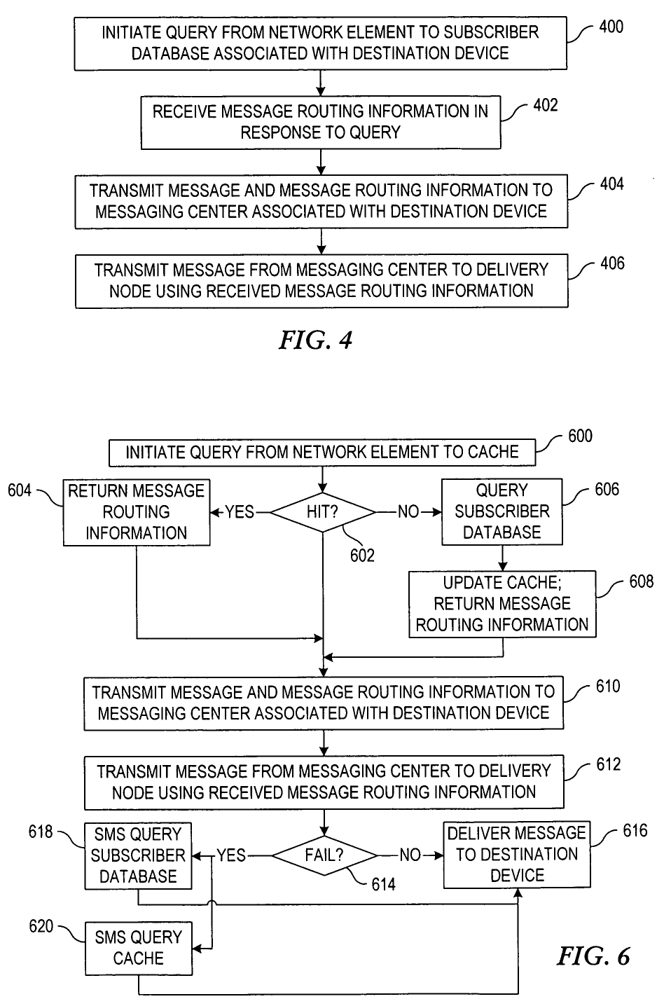

FIG. 4 is a flow diagram illustrating one embodiment of a method for reducing queries associated with the transmission of messages over a network. A query is initiated 400 from a product/network element to a subscriber database associated with the destination device. As previously indicated, one such subscriber database is an HLR. The network element initiating the query receives 402 message routing information in response to the query. This routing information includes an address of the delivery node to which the destination device is registered, such as an MSC/VLR, SGSN, or the like. The message and the message routing information is transmitted 404 to a messaging center associated with the destination device, such as an SMSC. The messaging center transmits 406 the message to a delivery element using the received message routing information, whereby the delivery element can thereafter deliver the message to the destination device.

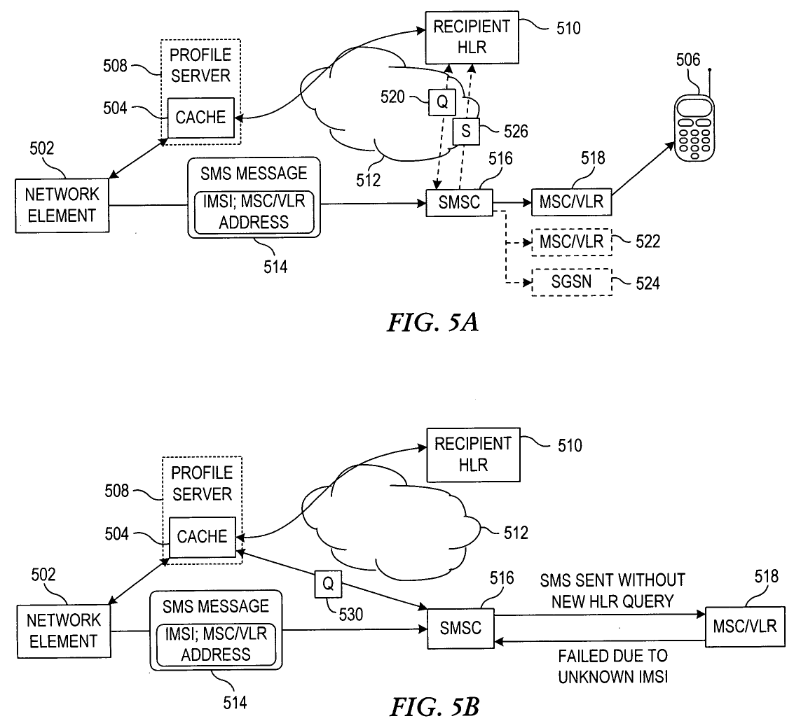

Caching may also be used in connection with the present invention to further reduce query volume. FIG. 5A is a block diagram illustrating one embodiment using a caching arrangement to store the information obtained from the recipient subscriber database for a configurable time. The network element 502 queries a cache 504 with the MS 506 (recipient) subscriber identity (e.g., MSISDN) to request the MS's IMSI and MSC/VLR address. Such a query may be made, for example, using an XML-based message. The cache 504 may be implemented in an existing network element, such as a profile server 508, and may be shared by multiple products. An operator can configure the cache 504 to store the MSC/VLR address for any configurable time, such as 20 minutes. Where the network element 502 has recently, i.e., within the configurable time, retrieved the MSC/VLR address from the HLR 510, no further query to the HLR 510 is required, as the cache 504 can provide this information to the network element 502.

If the information is not located at the cache 504, a query is made to the recipient HLR 510 with MS 506 MSISDN using, for example, the “MAP-SEND-ROUTING-INFO-FOR-SM” service to obtain the MS's 506 IMSI and MSC/VLR address. Such a query may be made over the SS7 network 512, using MNP for example. The network element 502 will receive the information, and the cache 504 will store the information for the configurable time.

The network element 502 sends the message, an SMS message 514 in the illustrated embodiment, to the SMSC 516 as previously described. The SMS message 514 includes the MSC/VLR address of the MSC/VLR 518 to which MS 506 is expected to be registered, and the SMSC 516 can send the SMS message to the MSC/VLR 518 without requiring a new query to the HLR 510.

If the SMS transmission to the MSC/VLR 518 fails, the SMSC can query 520 the HLR 510 with the MSISDN using, for example, the “MAP-SEND-ROUTING-INFO-FOR-SM” service to obtain the MS's 506 IMSI and MSC/VLR address. Such failure may occur where the MS 506 has moved to a new MSC/VLR, but in this case the delivery will fail due to the IMSI being unknown, and the new query 520 will provide the latest MSC/VLR 522 address, SGSN 524 address, etc. As previously indicated, if such a query 520 by the SMSC 516 to the HLR 510 results in obtaining the same MSC/VLR address as was received with the SMS message 514, the SMSC 516 will not attempt another transmission of the SMS message to that same MSC/VLR 518 in accordance with one embodiment of the invention. Rather, the SMSC 518 may directly provide the status 526 such as by directly sending a “MAP-REPORT-SM-DELIVER-STATUS” to the HLR 510, which will set the Message Waiting Data into the HLR 510 so that the HLR 510 will set the appropriate alert flag.

The embodiment of FIG. 5A represents an example where a cache 504 is provided, but the SMSC 516 is not using the cache 504. In accordance with another embodiment of the invention, the SMSC 516 can also query the cache 504 to further reduce subscriber database queries, as illustrated in FIG. 5B. FIG. 5B uses reference numbers common to those identified in FIG. 5A. In this embodiment, the network element 502 again queries the profile server 508 or other network entity (if any) to which the cache 504 is associated. The SMS message 514 is sent with the IMSI and MSC/VLR address to the SMSC 516, and the SMSC 516 sends the SMS message to the MSC/VLR 518 corresponding to the MSC/VLR address provided by the network element 502. Assuming a failure (e.g., IMSI unknown), the SMSC 516 directly queried the HLR 510 in the embodiment of FIG. 5A. However, in the embodiment of FIG. 5B, the SMSC 516 may query 530 the profile server 508 or other network element associated with the cache 504. The SMSC 516 may query 530 the profile server 508 with the MSISDN, and an indication that up-to-date information is required. Again, the query 530 may be performed using an XML-based message to request the recipient IMSI and MSC/VLR address, although other message types may be used. Since the SMSC 516 needs a new parameter to indicate that it requires the latest MSC/VLR address, a new query from the profile server 508 to the HLR 510 may be triggered, even if based on the configuration time (e.g., 20 minutes) the MSC/VLR value would still appear to be value. In this manner, the cache is reloaded with up-to-date information which may further reduce additional queries to the HLR 510.

When a cache 504 is used between the SMSC 516 and HLR 510 in this manner, MAP version 3 (v3) may be preferable to query the HLR, as use of MAP v3 will return both the MSC/VLR and SGSN addresses. However, the present invention is applicable in any case, i.e., where only an MSC/VLR address is provided; where only an SGSN address is provided; or where both MSC/VLR and SGSN addresses are provided. The invention is also applicable where the MS is registered with additional/other network elements than an MSC/VLR and/or SGSN. For example, this may be the case for future technologies.

FIG. 6 is a flow diagram illustrating one embodiment of a method implementing a cache for reducing queries associated with the transmission of messages over a network. A query is initiated 600 from the network element to the cache, or in one embodiment to another network element to which the cache is associated. If a cache hit occurs as determined at decision block 602, the cache returns 604 the message routing information. If a cache miss occurs, the cache or associated network element queries 606 the subscriber database to obtain the message routing information. When the information is provided by the subscriber database, the cache is updated, and the message routing information is returned as shown at block 608.

When the network element has received the message routing information either directly from the cache or indirectly from the subscriber database, the subject message and the message routing information are transmitted 610 to the messaging center associated with the destination device. The message is then transmitted 612 from the messaging center to a delivery node using the received message routing information. For example, the delivery node may be an SGSN, and the message routing information may include an SGSN address where the user of the destination device is registered. If there is no delivery failure from the messaging center to the delivery node as determined at decision block 614, the message is delivered 616 to the destination device. Otherwise, the SMS may directly query 618 the subscriber database, or alternatively may query 620 the cache if configured to do so. In response to such a query 618, 620, the message is provided to the proper delivery node, and ultimately delivered 616 to the destination device.

In accordance with one embodiment of the invention, the message(s) being transmitted are MMS messages. With current technology, sending an MMS message from a first MS (MS-A) to a second MS (MS-B) can create a large number of procedures towards the HLR. Such an example was illustrated in connection with the description of FIG. 1, where approximately eleven or more procedures occur towards the HLR. In accordance with one embodiment of the invention, the system is optimized by sending the MSC/VLR, SGSN, or other network element address where the recipient device is registered, from a sender-side MMSC (MMSC-A) to a recipient-side MMSC (MMSC-B). This may be performed, for example, where the MMS message is transferred via the MM4 interface. The MM4 interface refers to the interface between MMS relay/servers belonging to different Multimedia Messaging Service Environments (MMSEs), and is used to transfer messages therebetween. Thus, the MM4 interface is the interface between MMSCs for inter-carrier interworking, and currently such interworking between MMSCs is based on the Simple Mail Transfer Protocol (SMTP). The recipient MMSC-B can use this received address to insert this information in its charging record or prepaid query, without having to query the HLR to the information. In one embodiment of the invention, the MMSC-B also has the ability to provide this information to a Push Proxy Gateway (PPG) functionality, where the PPG may use the received IMSI to determine the operator and to select the SMSC. Further, the PPG may forward the received address (e.g., MSC/VLR address) to the SMSC to that the SMSC does not have to query the HLR. As can be seen, providing the MSC/VLR or other such address and/or the IMSI of the recipient MS can further reduce HLR or other subscriber database queries.

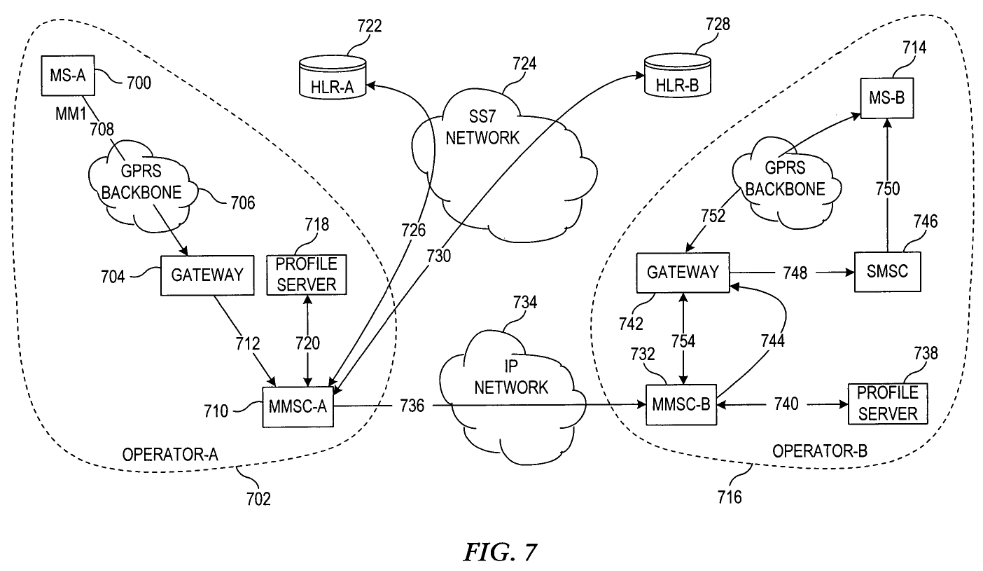

FIG. 7 is a block diagram illustrating one embodiment of the invention where subscriber database queries are reduced in connection with the transfer of MMS messages. FIG. 7 is described in connection with GPRS data networks, although the invention is equally applicable to other network environments. For ease of description, some procedures and HLR queries are not illustrated or described, such as the HLR queries associated with GRPS attach/detach procedures.

In the exemplary embodiment of FIG. 7, a sender mobile station MS-A 700 is operating within a first operator network shown as the operator-A network 702. The user of MS-A sends an MMS message to the gateway 704 via the GPRS backbone 706 as illustrated by path 708. The gateway 704 represents a Push Proxy Gateway (PPG), WAP gateway, or the like. In accordance with Third Generation Partnership Project (3GPP) standards (e.g., 3GPP TS 23.140), the MMS message may be submitted from the MMS user agent of MS-A 700 to the gateway 704 via an MM1 interface. The MMS message may be forwarded from the gateway 704 to the MMSC-A 710 using, for example, an HTTP POST as shown by path 712. The HTTP POST includes the MSISDNs of MS-A-700 as well as the recipient MS-B 714 associated with the operator-B network 716. The MMSC-A 710 may check for user prepaid accounts and/or user call barring preferences with a profile server 718 as illustrated on path 720.

The MMSC-A 710 queries its associated HLR-A 722 or other subscriber database via the SS7 network 724 as illustrated on path 726. The query uses the MSISDN of the user of MS-A 700 (user-A) to determine whether user-A is roaming from the MSC/VLR address. MMSC-A 710 also queries the HLR-B 728 associated with the intended recipient MS-B 714, as illustrated on path 730. By way of this query, the MMSC-A 710 can obtain MS-B's IMSI that is used to obtain the address of MMSC-B 732. The IMSI and MMSC-B 732 address is then returned to MMSC-A 710.

With this information, MMSC-A 710 sends the MMS message, including the IMSI of MS-B 714 and the MSC/VLR address, to MMSC-B 732 via the IP network 734 via the MM4 interface as shown on path 736. The MMSC-A 710 can determine which MMSC the message is to be sent to based on the IMSI, from which the operator ID can be determined, and the recipient MMSC is associated with that operator. By including the MSC/VLR address and the IMSI on the MM4 interfaces, the MMSC-B 732 does not need to perform a query to the HLR-B 728 to obtain this information. Ordinarily, the MMSC-B 732 would have to perform such a query to HLR-B 728 to find the MSC/VLR address, which can be added to the charging record and allows the billing system to determine if user-B is roaming.

In addition, the IMSI may be used by MMSC-B 732 to determine whether MS-B 714 belongs to the operator/virtual operator. More particularly, the IMSI may be uploaded to the profile server 738 which determines the operator/virtual operator ID after analyzing the IMSI.

In one embodiment, the MMSC-B also sends the MSC/VLR (or other entity) address to the Push Proxy Gateway, shown in FIG. 7 as the gateway 742. More particularly, when the MMSC-B 732 receives the message from the MMSC-A 710, it may check for user prepaid accounts and/or user call barring preferences with a profile server 738 as illustrated on path 740. The MMSC-B 732 may then forward the received MSC/VLR address and the MS-B 714 IMSI to the gateway 742 as shown on path 744. In one embodiment, this information is sent via the Push Access Protocol (PAP). In general, the PAP is used by a Push Initiator (PI) to access a PPG. In the illustrated embodiment, the MMSC-B 732 serves as the PI to the gateway 742, and the PAP is generally tunneled through Internet protocols such as HTTP.

In such a manner, the MMSC-B 732 may send the IMSI and MSC/VLR address to the gateway 742. Using the IMSI, the gateway 742 can determine the operator and identify the appropriate SMSC 746 to contact. The gateway 742 in turn sends the IMSI of MS-B 714 and the MSC/VLR address to the identified SMSC 746 as shown on path 748. This information may be sent from the gateway 742 to the SMSC 746 via an SMS message, for example. The SMSC 746 receives the information, and because the SMSC 746 now has the MSC/VLR address, the SMSC 746 does not need to query the HLR-B 728 to obtain it. The SMSC 746 therefore has the information needed to notify the MS-B 714 of an incoming MMS message, as illustrated on path 750. When the MS-B 714 receives such a notification, it can perform a fetch function as shown on path 752 to the gateway 742, which prompts the gateway 742 to retrieve the MMS message as shown on path 754. The gateway 742 may obtain the MMS message using, for example, an HTTP GET function, whereafter the MMS message may be provided to the targeted recipient MS-B 714.

For an MMS embodiment such as described in connection with FIG. 7, there are various manners in which the IMSI, MSC/VLR or SGSN address, or other such information can be provided to the MMSC associated with the targeted recipient. For example, the information may be provided from the originator MMSC to the recipient MMSC by adding an optional field(s) in the protocol used on the MM4 interface. This optional field(s) can be used to provide the IMSI and MSC/VLR address for example. Further, the to eliminate the need for the SMSC to query the HLR-B 728, the information may be send in a new or unused field associated with the PAP protocol.

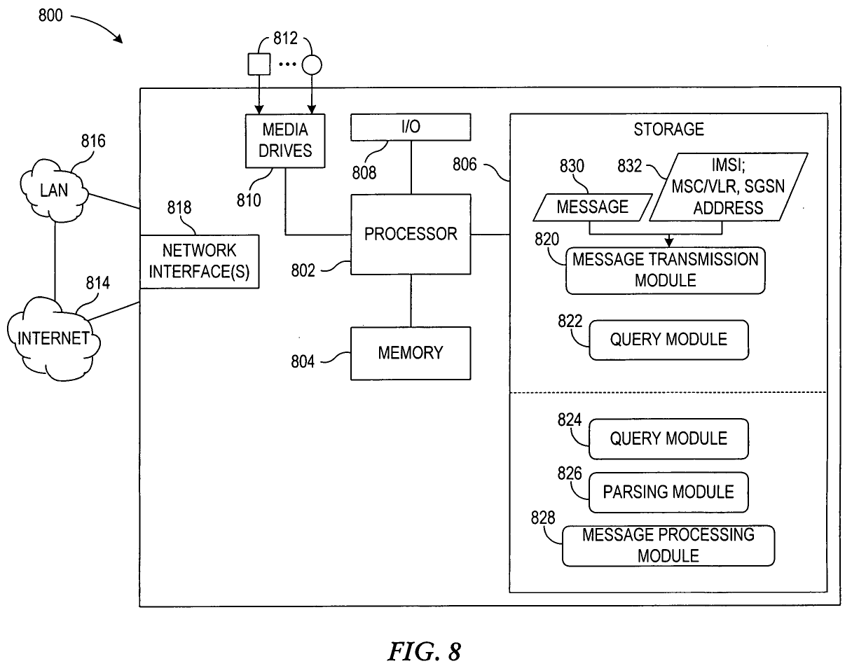

Hardware, firmware, software or a combination thereof may be used to perform the functions and operations in accordance with the invention. An example of a representative computing implementation of a network element 800 capable of carrying out operations in accordance with the invention is shown in FIG. 8. The network element 800 represents any network element that can query the subscriber database and provide information to a recipient messaging center in accordance with the present invention. Such a network element may include, for example, a WAP gateway, presence server, terminal management server, messaging gateway, payment server, MMSC, etc. The network element 800 may also represent a receiving messaging center, such as an SMSC or MMSC as described in greater detail below.

The representative computing arrangement suitable for performing the various functions and operations in accordance with the present invention includes a central processor 802, which may be coupled to memory 804 and storage 806. The processor 802 carries out a variety of standard computing functions as is known in the art, as dictated by software and/or firmware instructions. The storage 806 may represent firmware, hard-drive storage, etc. The storage 806 may also represent other types of storage media to store programs, such as programmable ROM (PROM), erasable PROM (EPROM), etc. The processor 802 may communicate with other internal and external components through input/output (I/O) circuitry 808. The computing system 800 may also include one or more media drive devices 810, including hard and floppy disk drives, CD-ROM drives, DVD drives, and other hardware capable of reading and/or storing information. In one embodiment, software for carrying out the operations in accordance with the present invention may be stored and distributed on CD-ROM, diskette or other form of media capable of portably storing information, as represented by media devices 812. These storage media may be inserted into and read by the media drive devices 810. Such software may also be transmitted to the network element 800 via data signals, such as being downloaded electronically via a network, such as the Internet 814, Local Area Network (LAN) 816, or other network. One or more network interfaces 818 provide the data transmission and receiving capabilities for the network element 800 to communicate with the appropriate networks, such as the LAN 816, Internet 814 or other data networks, SS7 network, etc.

In accordance with one embodiment of the invention, the storage 806, memory 804, and/or media devices 812 store the various programs and data used in connection with the present invention. In the illustrated embodiment of FIG. 8, the storage 806 is shown storing some of the various program modules operable in connection with the processor 802, as well as relevant data. Where the network element 800 represents a sending network element (e.g., network element 210 of FIG. 2), the storage 806 may include, for example, a message transmission module 820 and query module 822. Where the network element 800 represents a receiving network element (e.g., messaging center 212 of FIG. 2), the storage 806 may include, for example, a query module 824, parsing module 826, and message processing module 828.

A sending network element according to the present invention includes a query module 822, which performs the query(s) to the various subscriber databases. One such query includes the query to the recipient-side HLR to obtain the MSC/VLR or SGSN address and the IMSI of the recipient MS. The information received via such a query is shown at data block 832, which may be stored in storage 806, memory 804, or elsewhere. The message transmission module 820 prepares the message 830 (e.g., SMS, MMS message) to be transmitted along with the information 832, which is then transmitted over the IP network. In this manner, a sending network element 800 can provide the message routing information (e.g., IMSI, MSC/VLR address) to the messaging center.

A receiving network element such as a messaging center according to the invention includes a parsing module 826 to parse the incoming information. The message processing module 828 determines from the parsed information whether the message routing information was received, and if so whether the identified MSC/VLR or SGSN indicated a failure (e.g., IMSI unknown). If the message routing information was received and did not result in a failure by the identified MSC/VLR or SGSN, the message processing module coordinates delivery of the message to the MSC/VLR or SGSN identified by the provided address. Otherwise, a query module 824 provides a contingency procedure to query the HLR to obtain the appropriate MSC/VLR or SGSN address, as previously described.

The computing arrangement 800 of FIG. 8 is provided as a representative example of a computing environment in which the principles of the present invention may be applied. From the description provided herein, those skilled in the art will appreciate that the present invention is equally applicable in a variety of other computing arrangements.

The foregoing description of the exemplary embodiment of the invention has been presented for the purposes of illustration and description. It is not intended to be exhaustive or to limit the invention to the precise form disclosed. Many modifications and variations are possible in light of the above teaching. It is intended that the scope of the invention be limited not with this detailed description, but rather defined by the claims appended hereto.

1. A system for reducing database queries in connection with message transmissions, comprising:
a subscriber database for storing message routing information for a plurality of mobile device subscribers, the message routing information including subscriber information and addresses of network nodes to which the subscribers are currently registered;
a sending network element configured to retrieve the message routing information from the subscriber database for at least one destination subscriber among the plurality of mobile device subscribers, wherein the sending network element is configured to transmit at least one message and the message routing information towards the destination subscriber; and
a messaging center coupled to receive the message and the message routing information from the sending network element via a data network, and to facilitate transmission of the message to a mobile device of the destination subscriber using to the message routing information received from the sending network element.

2. The system as in claim 1, further comprising a cache to store the message routing information for use with transmission of at least one subsequent message towards the destination subscriber.

3. The system as in claim 2, wherein the sending network element is coupled to the cache and configured to query the cache to obtain the stored message routing information.

4. The system as in claim 3, wherein the network element is configured to transmit the message and the stored message routing information from the cache, if the cache contains the message routing information.

5. The system as in claim 3, wherein the cache is configured to retrieve the message routing information from the subscriber database if the cache does not contain the message routing information.

6. The system as in claim 2, wherein the messaging center is further configured to query the cache to request that the cache obtain the stored message routing information if the message routing information is not received by the messaging center, or if the subscriber information is unknown to the network node identified by the address provided via the message routing information.

7. The system as in claim 1, wherein the messaging center is configured to query the subscriber database to obtain the message routing information if the message routing information is not received by the messaging center or if the subscriber information is unknown to the network node identified by the address provided via the message routing information.

8. The system as in claim 1, further comprising a Mobile Switching Center/Visiting Location Register (MSC/VLR) to which the destination subscriber is currently registered, and wherein the address of the network node to which the destination subscriber is currently registered comprises at least the address of the MSC/VLR to which the destination subscriber is currently registered.

9. The system as in claim 8, wherein the subscriber information comprises a unique subscriber identifier identifying the destination subscriber, and wherein the messaging center is configured to transmit the message to the MSC/VLR for delivery to the destination subscriber identified by the unique subscriber identifier.

10. The system as in claim 8, further comprising a Serving GPRS Support Node (SGSN) to which the destination subscriber is currently registered, and wherein the address of the network node to which the destination subscriber is currently registered further comprises the address of the SGSN to which the destination subscriber is currently registered.

11. The system as in claim 10, wherein the subscriber information comprises a unique subscriber identifier identifying the destination subscriber, and wherein the messaging center is configured to transmit the message to the SGSN for delivery to the destination subscriber identified by the unique subscriber identifier.

12. The system as in claim 1, further comprising a Serving GPRS Support Node (SGSN) to which the destination subscriber is currently registered, and wherein the address of the network node to which the destination subscriber is currently registered comprises at least the address of the SGSN to which the destination subscriber is currently registered.

13. The system as in claim 1, wherein the subscriber information comprises an International Mobile Subscriber Identity (IMSI).

14. The system as in claim 1, wherein the network element is configured to retrieve the message routing information from the subscriber database using a contact address of the mobile device of the destination subscriber as an index to the subscriber database.

15. The system as in claim 14, wherein the contact address comprises a Mobile Subscriber ISDN Number (MSISDN) of the mobile device of the destination subscriber.

16. The system as in claim 1, wherein the subscriber database comprises a Home Location Register (HLR) in which the destination subscriber is registered.

17. The system as in claim 1, wherein the network element comprises any of a WAP gateway, presence server, terminal management server, messaging gateway, payment server, or a messaging center.

18. The system as in claim 1, further comprising a signaling network, wherein the network element is configured to query the subscriber database of the destination subscriber via the signaling network.

19. The system as in claim 18, wherein the signaling network comprises an SS7 network.

20. The system as in claim 1, wherein the sending network element comprises a sending Multimedia Messaging Service Center (MMSC) and the messaging center comprises a receiving MMSC, and wherein the message comprises a Multimedia Messaging Service (MMS) message.

21. The system as in claim 20, further comprising:
a push proxy gateway coupled to the receiving MMSC to receive the subscriber information and the network node address provided by the sending MMSC; and
a notification node operable to notify a mobile station associated with the destination subscriber that the MMS message is available, wherein the notification node is coupled to receive the subscriber information and the network node address for use in identifying the destination subscriber.

22. The system as in claim 21, wherein the receiving MMSC is configured to provide the subscriber information and the network node address to the push proxy gateway via a field of a Push Access Protocol (PAP).

23. The system as in claim 22, wherein the push proxy gateway is configured to provide the subscriber information and the network node address to the notification node via a Short Message Service (SMS) message.

24. The system as in claim 23, wherein the notification node comprises a Short Message Service Center (SMSC).

25. The system as in claim 1, wherein the sending network element comprises a sending Multimedia Messaging Service Center (MMSC) and the messaging center comprises a receiving MMSC, and wherein the sending MMSC is configured to transmit the at least one message and the message routing information to the receiving MMSC via an MM4 interface.

26. A method for reducing queries associated with the transmission of messages over a network, comprising:
initiating a query, from at least one network element involved in the transmission of messages, to a subscriber database associated with a destination subscriber;
in response to the query, receiving message routing information for transmitting at least one message from the network element towards the destination subscriber;
transmitting the message and the message routing information from the network element to a messaging center associated with the destination subscriber; and
transmitting the message from the messaging center to a delivery node for ultimate delivery to the destination subscriber, wherein the message is transmitted from the messaging center to the delivery node identified by the message routing information received from the network element.

27. The method of claim 26, further comprising querying the subscriber database by the messaging center to obtain the message routing information if the message routing information was not received with the message.

28. The method of claim 26, further comprising querying the subscriber database by the messaging center to obtain the message routing information if delivery of the message to the delivery node fails.

29. The method of claim 28, wherein querying the subscriber database by the messaging center comprises querying the subscriber database by the messaging center if subscriber information provided via the message routing information is unknown to the delivery node identified by the message routing information.

30. The method of claim 28, further comprising providing delivery status by the messaging center to the subscriber database if an address of the delivery node obtained from the subscriber database is the same as the address of the delivery node obtained from the message routing information provided by the at least one network element.

31. The method of claim 26, further comprising storing the message routing information that was received in response to the query in a cache.

32. The method of claim 31, further comprising initiating a query from the at least one network element to the cache to obtain the message routing information for transmission of a subsequent message to the messaging center.

33. The method of claim 31, further comprising initiating a query from the messaging center to the cache to request that the cache obtain updated message routing information if the subscriber information is unknown to the delivery node identified by the message routing information.

34. The method of claim 26, wherein the message routing information for the destination subscriber comprises a subscriber identifier and an address of the delivery node to which the destination subscriber is registered.

35. The method of claim 34, wherein the subscriber identifier comprises an International Mobile Subscriber Identity number (INISI), and wherein the address of the delivery node comprises an address for one or more of a Mobile Switching Center/Visiting Location Register (MSC/VLR) and a Serving GPRS Support Node (SGSN).

36. A network element for facilitating the transmission of messages over a network, comprising:
a query module configured to formulate a query to a subscriber database associated with a destination subscriber;
a network interface to transmit the query and to receive message routing information in response thereto;
a message transmission module to associate the message with the message routing information; and
wherein the network interface transmits the message and associated message routing information to a messaging center serving the destination subscriber, wherein the message routing information includes a subscriber identity of the destination subscriber and an address of a delivery node for use by the messaging center in delivering the message to the destination subscriber.

37. A computer-readable medium having instructions stored thereon which are executable by a computer system for reducing queries associated with the transmission of messages over a network by performing steps comprising:
initiating a query to a subscriber database associated with a destination subscriber;
receiving message routing information for transmitting a message towards the destination device; and
transmitting the message and the message routing information to a messaging center associated with the destination subscriber to facilitate transmission of the message from the messaging center to the destination subscriber using the message routing information.
